(19) United States
(12) Patent Application Publication
(10) Pub. No.: US 2016/0218604 A1
(43) Pub. Date: Jul. 28, 2016

(54) METHOD OF MANUFACTURING A STATOR OF A CLAW-POLE MOTOR

(71) Applicant: Büehler Motor GmbH, Nurnberg (DE)

(72) Inventors: Olai Ihle, Eckental (DE); Klaus Weiske, Schwaig (DE)

(73) Assignee: Büehler Motor GmbH, Nurnberg (DE)

(21) Appl. No.: 15/088,451

(22) Filed: Apr. 1, 2016

Related U.S. Application Data
(63) Continuation of application No. 13/993,241, filed on Aug. 20, 2013.

(30) Foreign Application Priority Data
Feb. 15, 2011 (DE) 102011004149.4

(51) Int. Cl. H02K 15/02

(52) U.S. Cl. CPC H02K 15/022

(57) ABSTRACT

A claw-pole motor for driving a centrifugal pump includes stator laminations in the form of annular discs with claw poles adjoining said stator laminations, which claw poles are arranged opposite permanent-magnet poles of a rotor, a ring-shaped winding and an insulating body, which is arranged between the stator laminations and the winding, and a magnetic return path ring, which is arranged radially around the winding and the stator laminations and bears fixedly against the stator laminations. The claw pole is achieved by the magnetic return path ring comprising at least two lamination rings, which are nested coaxially one inside the other and each have at least one cutout, and being the cutouts are offset with respect to one another through an angle such that said cutouts do not overlap one another, wherein the two cutouts define two angular ranges α1, α2, the lamination rings are connected fixedly to one another at a first connection point, which is removed from the cutouts, in the angular range α1 and likewise at another second connection point, which is removed from the cutouts, in the angular range α2.

### CROSS-REFERENCE TO RELATED APPLICATIONS

The present patent application is a continuation of U.S. application Ser. No. 13/993,241, which is a nationalization of International Application No. PCT/DE2012/200004, filed Jan. 27, 2012, which is based on, and claims priority from, German Application No. DE 10 2011 004 149.4, filed Feb. 15, 2011, all of which are incorporated herein by reference in their entireties.

### BACKGROUND OF THE INVENTION

(1) Field of the Invention

The present invention relates to a stator of a claw-pole motor for driving a centrifugal pump. The stator consists of stator laminations in the form of annular discs with claw poles adjoining the stator laminations, which claw poles are arranged opposite permanent-magnet poles of a rotor, a ring-shaped winding and an insulating body, which is arranged between the stator laminations and the winding, and a magnetic return path ring which is arranged radially around the winding and the stator laminations and is in a fixed position against the stator laminations.

(2) Description of Related Art including Information Disclosed under 37 CFR 1.97 and 1.98

A stator is known from U.S. Pat. No. 7,692,355 in which a return ring with enlarged diameter is mounted on a stator, and the diameter of the return ring is reduced in a deformation process and thereby fixedly attached to the stator. The strength of the connection is not optimal, however, because of the unavoidable spring-back due to the elasticity of the material return ring is made of This can lead to vibrational effects and undesirable noises during the useful life of the motor, accentuated under varying temperature conditions.

A generic stator is known from US Patent Application No. 2010/111730 in which the return ring consists of a single rolled metal strip. The open return ring is slipped over the stator, squeezed together by means of a device and subsequently laser welded. The ends of the return ring consist of a tab and matching recess which interlock. The intermediate space between the areas being welded is closely toleranced since the space must be bridged by molten metal. Because the return ring is mounted on the wound stator, it is necessary as a precaution for the weld seams to extend outside the winding area to prevent damage to the winding as a result of the welding process. This limits the design freedom of the connection. The prior art return ring consists of a single rolled metal strip, thus, eddy currents in the return path can reduce the level of efficiency.

### BRIEF SUMMARY OF THE INVENTION

The object of the present invention is therefore to ensure a high degree of efficiency and a stable, play-free design of the stator in the case of a centrifugal pump of the generic type, with the result that no vibrations, noises or resonances occur, wherein the design is simple and the production is reliable and economical.

This object is achieved according to the present invention by the use of at least two lamination rings nested coaxially one inside the other instead of a single return metal sheet reduces the formation of eddies and increases the level of efficiency of the magnetic circuit. Further, it offers new design options as a result of the thinner sheet metal material. Tooling costs are also reduced as a result. The two cutouts make it possible to reduce the diameter of the return path ring enough to achieve an optimal, fixed connection with the stator. Because the cutouts are angularly offset with respect to one another, the return path ring is completely enclosed, and this too enhances the degree of efficiency. The first connection point acts to prevent displacement of the two lamination rings against one another, and it also serves as a pre-assembly connection and is necessary in order to achieve a fixed attachment to the stator via the second connection point. The second connection point is disposed between the two cutouts. Each of the cutouts defines a break in the circumferential direction which makes it possible to adjust the diameter of the return path ring. Stators with return path rings in which the cutouts are bridged by thin flexible ribs would also fall within the scope of patent protection, as long as the diameter of the return path rings is still capable of being reduced.

The lamination rings can be connected at the first connection point by beads or by means of resistance welding. In this case it is proposed that the first connection point be disposed proximate the second cutout which is defined by the ends of the second, and therefore outer, lamination rings. This prevents the formation of a free end on the second lamination ring that is not connected over a large angular range with the first lamination ring, thereby reducing vibrational tendencies. In the beading process, a stamp is pressed under high pressure into the superimposed lamination strips, thereby producing a projection in one of the laminations which is pressed into a recess in the other lamination. The beading and resistance welding processes are achievable at little cost and they reduce only negligibly the magnetic properties of the return path rings. It is also possible to employ other comparable connecting methods.

Notches on the second outer lamination ring ensure that the connection region between the two lamination rings does not fall within the edge region. The edge region functions as a connection region with the stator and should therefore have no additional function.

The second connection point can, according to demand, be implemented as a weld connection, flexible connection or snap-lock connection.

In a preferred exemplary embodiment the second outer lamination ring is welded in a laser welding process to the adjoining inner lamination ring at the edge of the tab. The advantage of this solution is that subsequent to welding the return path ring is no longer able to spring back, which produces a fixed, vibration free connection between the return path ring and the stator. Further, there is no risk of damage to the windings since the cutouts, and thus the ends of both lamination rings, are offset at an angle with respect to one another.

As a second solution according to the invention, the return path ring consists of at least two lamination rings nested coaxially one inside the other, each of which has at least one cutout, the cutouts being offset at an angle relative to one another so as not to overlap, wherein the two cutouts define two angular ranges α1, α2, the second lamination ring being fixedly connected to the first lamination ring and/or adjacent tabs of the second lamination ring at a connection point in the angular range α2. Here, in contrast to the first solution, no fixed connection point is provided between the two lamination rings before the return path ring is attached to the stator. This saves a working step. When joining both lamination rings on the stator, which can be done in succession or simultaneously, it must be ensured that the cutouts are far enough removed from one another so that there is no overlapping between the cutouts or between a cutout and the connection point of the outer lamination ring. In the second solution a welded connection is preferred because it is possible by this means to connect the ends of the outer lamination ring as well as connect both lamination rings to one another in a simple manner.

To avoid potential vibrations of the second lamination ring, it may be expedient to provide an additional weld seam by means of which both lamination rings are affixed to one another. According to a first modification of the invention, the additional weld seam can be arranged at a right angle to the weld seams between the tab of the second lamination ring and the first lamination ring, requiring no change in geometry to the lamination rings. As a further possibility for avoiding vibrations, the additional weld seam is provided as an extension to the weld seams of the second connection point between the side tabs and the tab of the second lamination ring. A second seam weld can be omitted in the event a first connection point is disposed between the two lamination rings proximate the second free space. Then the free end of the second lamination ring need not necessarily be fixed via a connection between the two lamination rings proximate the second free space, if such a stable fixation is achieved once the stator is installed in the motor housing. A fixation of this type can be produced, for example, by housing ribs at the appropriate locations.

### BRIEF DESCRIPTION OF THE SEVERAL VIEWS OF THE DRAWINGS

The invention is better understood by reading the following Detailed Description of the Preferred Embodiments with reference to the accompanying drawing figures, in which like reference numerals refer to like elements throughout, and in which:

FIG. 1a shows a first embodiment of the return path ring,

FIG. 1b is a top view of the welded return path ring of FIG. 1a,

FIG. 1c is a top view of a modification of FIG. 1b,

FIG. 1d is a top view of a further modification of FIG. 1b, or a second modification,

FIG. 1e schematically shows a welding apparatus,

FIG. 2a shows a second embodiment of the return path ring,

FIG. 2b is a partial sectional view according to FIG. 2a,

FIG. 3 shows a third embodiment of the return path ring,

FIG. 4 shows a stator of a claw-pole motor without return path ring and

FIG. 5 is a sectional view through a centrifugal pump employing the present invention.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

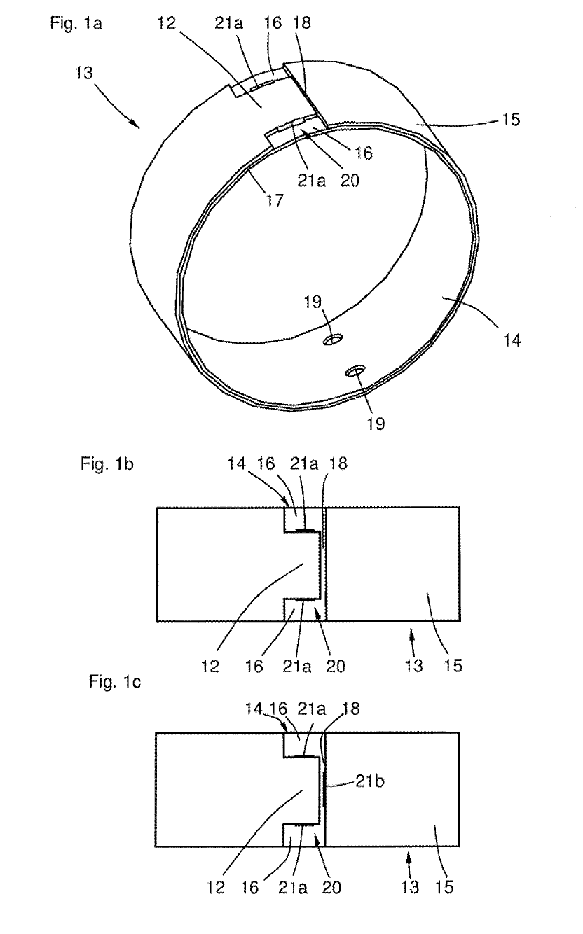

FIG. 1a shows a first embodiment of a return path ring 13 with a first lamination ring 14, a second lamination ring 15 which is attached coaxially to and about the first lamination ring 14, a first cutout 17 in the first lamination ring 14, a second cutout 18 in the second lamination ring 15, notches 16 adjoining the second cutout 18 of the second lamination ring 15 thereby leaving a tab 12, a first connection point 19 and a second connection point 20 between the two lamination rings 14, 15, wherein the first connection point 19 is defined by two beads and the second connection point 20 is defined by two weld seams 21a. The weld seams are laser-welded seams. Both connection points are separated from one another in the example shown by approximately 180°.

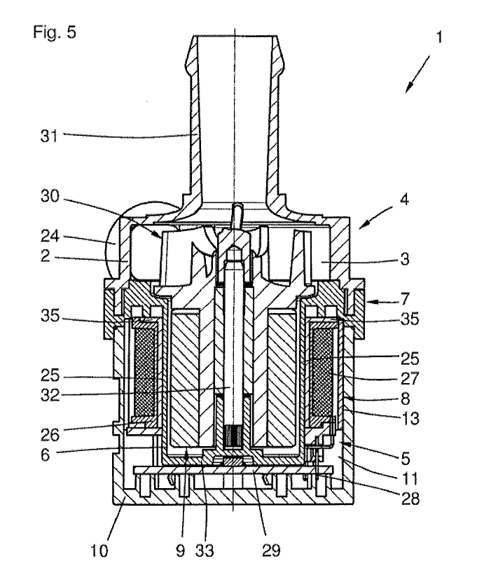

In the first embodiment as shown in FIGS. 1 and 5, the stator of the claw-pole motor for driving a centrifugal pump is made up of stator laminations in the form of annular discs 35, a rotor 9 with permanent-magnetic poles 41, claw poles 25 adjoining the stator laminations 35, which claw poles are arranged opposite the permanent-magnetic poles of the rotor, a ring-shaped winding 27, an insulating body 26, which is arranged between the stator laminations 35 and the winding 27, and a return path ring 13 arranged radially around the winding and the stator laminations, the return path ring fixedly bearing against the stator laminations 35.

The return path ring 13 is made up of at least two lamination rings 14, 15 nested coaxially one inside the other as inner and outer lamination rings, respectively, each having at least one cutout 17, 18, with the cutouts being offset at an angle with respect to one another so that they do not overlap, wherein the two cutouts define two angular ranges α1, α2 (FIG. 1e), and the lamination rings are fixed to one another at a first connection point 19 in the angular range α1, and the second lamination ring is fixed to the first lamination ring and/or adjoining tabs of the second lamination ring at a second connection point 20 in the angular range α2.

FIG. 1b shows a simplified top view of the welded return path ring of FIG. 1a with the first lamination ring 14, the second lamination ring 15, the tab 12, the notches 16, the second cutout 18, the weld seams 21a. The cutout 18 is dimensioned so that a secure, play-free connection can be consistently produced between the components to be connected under all tolerance conditions of a claw-pole stator and of the return path ring 13, and under the tolerance of the pressing force during assembly. To facilitate welding using a laser beam, two weld seams 21a are provided which are disposed a sufficient distance apart from one another in order to provide sufficient space for a clamping jaw and for the laser beam. The weld seams 21a connect the abutting lamination rings at least partially to one another, during operation they are stressed with shear and thus constitute a very robust and unyielding connection.

FIG. 1c shows a top view of a modification of FIG. 1b; here an additional weld seam 21b is shown between the first lamination ring 14 and the second lamination ring 15 in the region of the second cutout 18. This weld seam 21b serves primarily to prevent vibrations from occurring, it can also consist of two short weld seams in the edge regions of the return path ring 13.

A second modification of FIG. 1b is represented by FIG. 1d. Additional lateral tabs 40 are provided on the second lamination ring 15 proximate the second connection point 20 on both sides of the tab 12, which fill out only a portion of the notches 16, so that both the weld seam 21a between the two lamination rings 14 and 15 and a weld seam 21c between the two ends of the second lamination ring 15 on both sides can be formed as extensions of the weld seam 21a. FIG. 1b also represents a variant of the second solution according to the invention, in which no first connection point is present between the two lamination rings.

FIG. 1e shows a welding apparatus 22 with two movable clamping jaws and one stationary clamping jaw 23 that ensure a play-free attachment of the return path ring 13 to the claw-pole stator 8. A laser 34 produces a high-energy pulsed laser beam with a defined output and duration. During the welding process, the clamping jaws 23 press the return path ring 13 against the claw-pole stator 8. The stator components must be joined before being inserted into the welding device 23. For this purpose, the return path ring 13 after rolling is expanded somewhat so that it can be pushed effortlessly onto the claw-pole stator. The dimensions of the welding device are such that the laser beam is able to reach the welding spot unimpeded and to produce a sufficiently long weld seam 21a. The welding device is shown only in basic outline. A number of other embodiments are also feasible, this refers also to the number of clamping jaws and their shape.

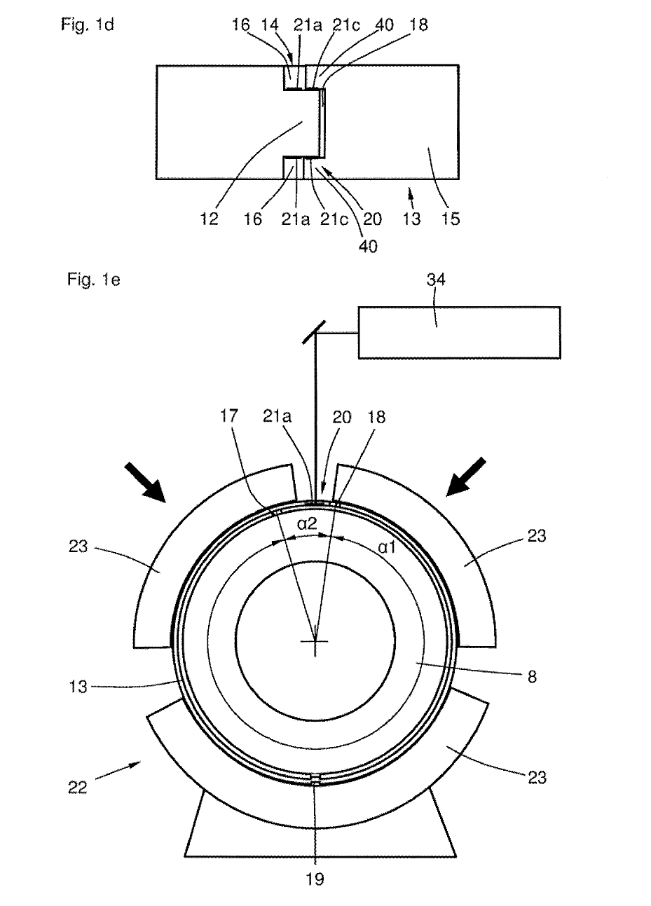

FIGS. 2a and 2b show a second embodiment of the return path ring 13 with lamination rings 14′, 15′, the cutouts 17′, 18′, the first connection point 19′ (FIG. 2a) and the second connection point 20′, which differs from the first embodiment in that the connection is a snap-lock connection with a locking tab 36 and a locking recess 37 (FIG. 2b) The return path ring 13 is mounted on the claw-pole stator in a device in which the return path ring that has been slid over the stator is compressed, thereby producing the snap-lock connection.

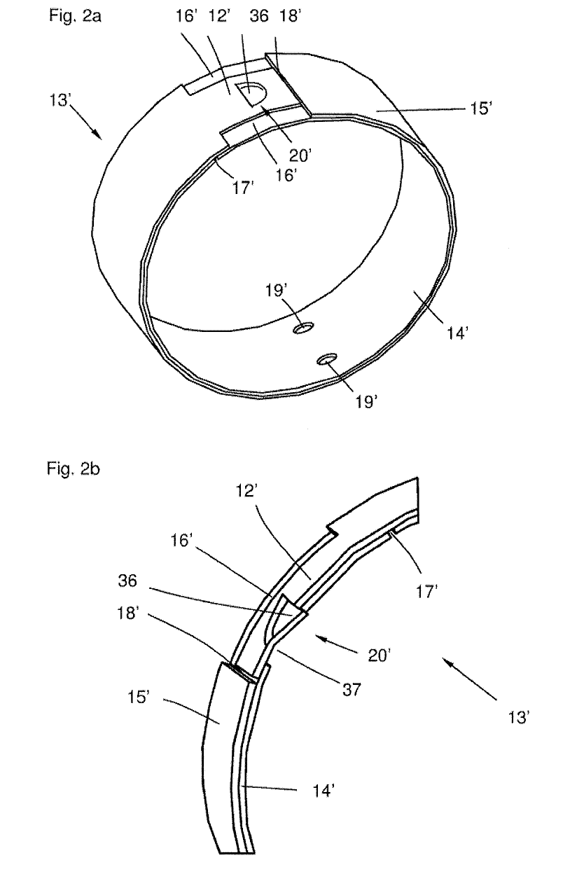

A third embodiment of the return path ring 13″ is shown in FIG. 3 with lamination rings 14″, 15″, cutouts 17″, 18″) and connection points 19″ and 20″ between the lamination rings. Here the connection point 20″ is designed as a flexible tab 38 that is bent into a fastening recess 39.

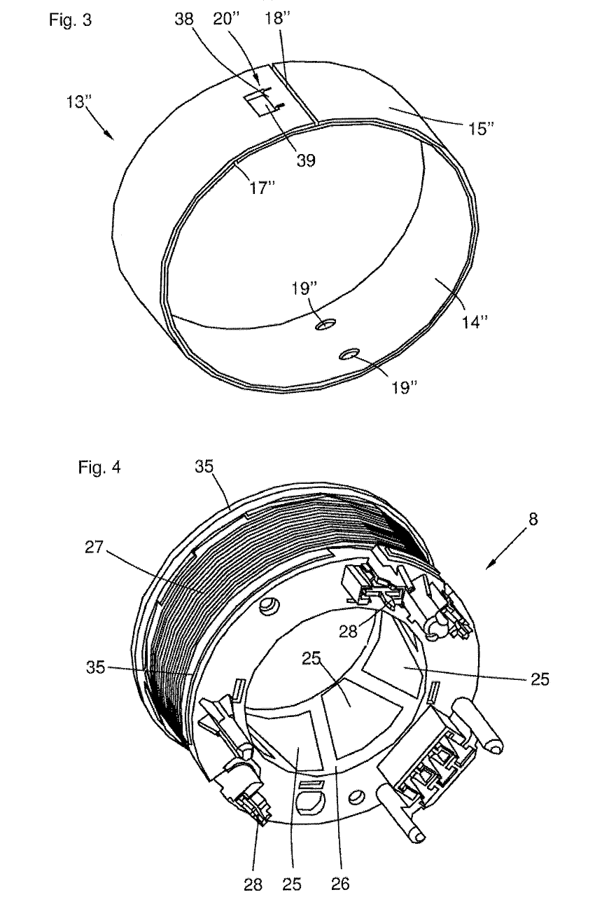

FIG. 4 shows the stator 8 of a claw-pole motor with an insulating body 26 in which claw poles 25 are imbedded. The claw poles are made of a single piece and designed with stator laminations 35 in the form of annular discs. The insulating body 26 is fitted with fastening means in one piece and with attachments 28. The return path ring that closes the magnetic circuit is not shown here.

A sample application of the stator is shown in FIG. 5. It shows a sectional view of a centrifugal pump 1 with a pump housing 2 which defines a pumping space 3, an intermediate housing part 7 with a can like partition wall 6, the claw-pole stator 8, the return path ring 13 and a motor housing part 10 that defines a motor compartment 11. The claw-pole stator 8 includes the insulating body 26, the winding 27 and the connectors 28. The connectors 28 in the form of contact pins establish an electrical connection with a circuit board 29. The insulating body 26 can be fabricated by overmolding of the claw-poles 25. Disposed within the separating can 6 is a permanent-magnetic rotor 9 which is mounted for rotatable movement and whose hub and pump impeller 30 form a single piece. The pump housing 2 together with a suction port 31 and a pressure port 24 form a single piece. The rotor is mounted on an axis 32 affixed in a base 33 of the separating can.

It is to be understood that the present invention is not limited to the illustrated embodiments described herein. Various types and styles of user interfaces may be used in accordance with the present invention without limitation. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE NUMERALS

1 Centrifugal pump
2 Pump housing
3 Pumping space
4 Housing section
5 Electric motor
6 can like partition wall
7 Intermediate housing part
8 Claw-pole stator
9 Rotor
10 Motor housing part
11 Motor compartment
12,12′ Tab
13,13′,13″ Return path ring
14,14′14″ First lamination ring
15,15′15″ Second lamination ring
16,16′ Notch
17,17′,17″ First cutout
18,18′18″ Second cutout
19,19′19″ First connection point
20,20′,20″ Second connection point
21a,21b,21c Weld seam
22 Welding apparatus
23 Clamping jaws
24 Pressure port
25 Claw-pole
26 Insulating body
27 Winding
28 Connectors
29 Circuit board
30 Pump impeller
31 Suction port
32 Axis
33 Base
34 Laser
35 Annular disc-shaped stator ring
36 Locking tab
37 Locking recess
38 Flexible tab
39 Fastening recess
40 Lateral tabs

We claim:

1. A method of manufacturing a stator (8) of a claw pole motor, to drive a centrifugal pump (1), the stator comprising annular-disc-shaped stator laminations (35) with adjoining claw poles (25), which are arranged opposite permanent-magnetic poles of a rotor (9), a ring-shaped winding (27) and an insulating-material body (26), which is arranged between the stator laminations (35) and the winding (27), and a short-circuit ring (13), arranged radially around the winding (27) and the stator laminations (35), which lies securely against the stator laminations (35), the method comprising the steps of:
a) assembling the short-circuit ring (13) from at least two sheet-metal rings (14, 15), coaxially nested into each other, each having at least one cut out (17, 18) which are dimensioned in such a manner that under all tolerance states of the claw pole stator and of the short-circuit ring (13) and under the tolerance of the contact pressure upon assembly there can always be produced a secure, play-free connection between the components to be connected,
b) arranging the cut outs (17, 18) offset at an angle to one another so that they do not overlap, wherein the two cut outs (17, 18) define two angular ranges α1, α2,
c) securely connecting the sheet-metal rings (14, 15) to one another at a first connecting site (19) in the angular range α1,
d) attaching the short-circuit ring (13) onto the stator laminations (35) with windings wound therearound and is pressed thereon in a play-free manner and
e) securely connecting the second sheet-metal ring (15) to the first sheet-metal ring (14) at a second connecting site (20) in the angular range α2 with the aid of tabs (12, 40) of the second sheet-metal ring (15).

2. A method according to claim 1, wherein in said step a), connection between the sheet-metal rings (14, 15) at the first connecting site (19) takes place via beads, resistance welding or another comparable connection type and in the attaching step, the second connecting site (20) is arranged in the vicinity of the second cut out (18) defined by ends of the second and thereby outer sheet-metal ring (15).

3. A method according to claim 1, wherein the outer sheet-metal ring (15) is provided with notches (16) in a region adjoining the cut out (18), so that a tab (12) remains which is narrower than the width of the inwardly adjoining ring.

4. A method according to claim 2, wherein the outer sheet-metal ring (15) is provided with notches (16) in a region adjoining the cut out (18), so that a tab (12) remains which is narrower than the width of the inwardly adjoining ring.

5. A method according to claim 1, wherein in said step e), at the second connecting site (20) in the angular range α2, the sheet-metal rings (14, 15) are welded to one another, connected to one another through bending or by snapping together.

6. A method according to claim 2, wherein in said step e), at the second connecting site (20) in the angular range α2, the sheet-metal rings (14, 15) are welded to one another, connected to one another through bending or by snapping together.

7. A method according to claim 3, wherein in said step e), at the second connecting site (20) in the angular range α2, the sheet-metal rings (14, 15) are welded to one another, connected to one another through bending or by snapping together.

8. A method according to claim 5, wherein the outer sheet-metal ring (15) is welded to the adjacent, inner sheet-metal ring (14) by a laser welding procedure at the edge of the tab (12).

9. A method according to claim 8, wherein the two sheet-metal rings (14, 15) are fixed to one another by an additional weld seam (21b).

10. A method according to claim 9, wherein the additional weld seam (21b) is made at right angles to weld seams (21a), between the tab (12) of the second sheet-metal ring (15) and the first sheet-metal ring (14).

11. A method according to claim 9, wherein an additional weld seam (21c) is produced, as an extension to the weld seams (21a), between lateral tabs (40) and the tab (12) of the second sheet-metal ring (15).
